(19) United States
(12) Patent Application Publication
(10) Pub. No.: US 2021/0291682 A1
(43) Pub. Date: Sep. 23, 2021

(54) PARKING AID SYSTEM, PARKING AID DEVICE, AND VEHICLE

(71) Applicant: HONDA MOTOR CO., LTD., Tokyo (JP)

(72) Inventor: Naoya SAKAKIBARA, Saitama (JP)

(21) Appl. No.: 17/202,356

(22) Filed: Mar. 16, 2021

(30) Foreign Application Priority Data
Mar. 18, 2020 (JP) 2020-047093

(51) Int. Cl. B60L 53/36; B60L 53/39; B60W 50/14

(52) U.S. Cl. CPC B60L 53/36; B60L 53/39; B60W 50/14; B60W 2050/146; B60L 2250/10; B60L 2250/16; B60W 2050/143; B60L 2240/62

(57) ABSTRACT

A vehicle 2 includes a power receiving unit 11 which receives electrical power sent from a power supply unit 4; a relative position acquisition unit 21 which acquires a relative position of the power receiving unit 11 relative to the power supply unit 4; and an alignment aid unit 22 which aids in alignment of the power receiving unit 11 relative to the power supply unit 4, by notifying to the driver of information relative to displacement of the power receiving unit 11 relative to the power supply unit 4, based on the relative position acquired by the relative position acquisition unit 21. The alignment aid unit 22 is switchable between a first notification which notifies the information relative to displacement by way of an image display device 12, and a second notification which notifies the information relative to displacement by way of a vehicle information presenting device 14.

This application is based on and claims the benefit of priority from Japanese Patent Application No. 2020-047093, filed on 18 Mar. 2020, the content of which is incorporated herein by reference.

### BACKGROUND OF THE INVENTION

### Field of the Invention

The present invention relates to a parking aid system, a parking aid device and a vehicle. In more detail, it relates to a parking aid system, a parking aid device and a vehicle which aid in parking of the vehicle, which is a vehicle receiving electrical power for battery charging supplied by non-contact power supply.

### Related Art

Conventionally, a configuration supplying electrical power for battery charging by non-contact power supply has been proposed. With the non-contact power supply of such a vehicle, a power supply unit by a power supply coil is provided in a road surface. In addition, a power receiving unit by a power receiving coil is provided to the bottom of the vehicle, and receives power with the power receiving unit electrical power for battery charging being sent from the power supply unit.

With the non-contact power supply of such a vehicle, in order to efficiently supply electrical power, it is necessary to park to align the power receiving unit with the power supply unit installed in the road surface. Patent Document 1 discloses a scheme for displaying an image of the positional relationship between a power supply unit and power receiving unit to aid in the driving by a driver in the alignment of these.

Patent Document 1: Japanese Patent No. 6534416

### SUMMARY OF THE INVENTION

However, in the case of displaying an image of the positional relationship between the power supply unit and power receiving unit as in the configuration disclosed in Patent Document 1, the vehicle comes to be driven while confirming the change in position of the power receiving unit relative to the power supply unit according to this image display. As a result thereof, the display screen is closely being watched, and thus there has been a problem in that the attention to the vehicle surroundings declines. In addition, in this image display, it has been considered to use the configuration of an image display device offered in navigation processing, for example; however, in the case of this image display device failing, there has been a problem in that it becomes difficult to aid in alignment.

The present invention has an object of providing a parking aid system, parking aid device and vehicle which prevent a decline in attention to the vehicle surroundings, and can aid in alignment, even in a case of an image display device failing.

A parking aid system according to a first aspect of the present invention aids in parking of a vehicle to a parking space that supplies electrical power for battery charging by non-contact, in which a power supply unit for sending the electrical power for battery charging is provided to the parking space; the vehicle includes: a power receiving unit that receives the electrical power for battery charging sent by the power supply unit; a relative position acquisition unit which acquires a relative position of the power receiving unit relative to the power supply unit; an alignment aid unit which aids in alignment of the power receiving unit relative to the power supply unit, by notifying a driver of information related to displacement of the power receiving unit relative to the power supply unit, based on the relative position acquired by the relative position acquisition unit; and an image display device which displays an image visible to the driver; and a vehicle information presenting device which presents vehicle information in a mode which the driver can confirm by sight or sound, in which the alignment aid unit is switchable between a first notification which notifies information related to the displacement by way of the image display device, and a second notification which notifies the information related to the displacement by way of the vehicle information presenting device.

According to the second aspect of the present invention, in this case, it is preferable for the alignment aid unit to switch between the first notification and the second notification according to an instruction from the driver.

According to the third aspect of the present invention, in this case, it is preferable for the vehicle information presenting device to include an audible tone speaker which produces an audible tone, and the alignment aid unit to change an interval of an audible tone according to a displacement amount along a vehicle front/rear direction of the power receiving unit relative to the power supply unit, in the second notification.

According to the fourth aspect of the present invention, in this case, it is preferable for the vehicle information presenting device to include a directional indicator light, and the alignment aid unit change a flashing pattern of the directional indicator light according to a displacement amount along a vehicle width direction of the power receiving unit relative to the power supply unit, in the second notification.

According to the fifth aspect of the present invention, in this case, it is preferable for the vehicle information presenting device to include a warning sound speaker which produces a warning sound of a collision avoidance system, and the alignment aid unit to change at least either or an interval and a tone of the warning sound according to a displacement amount along a vehicle front/rear direction of the power receiving unit relative to the power supply unit, in the second notification.

According to the sixth aspect of the present invention, in this case, it is preferable for the vehicle information presenting device to include at least a left speaker and a right speaker which can produce sound independently at left and right, and the alignment aid unit to change at least either of an interval and tone of sound produced at either of the left speaker and the right speaker according to a displacement amount along a vehicle width direction of the power receiving unit relative to the power supply unit.

According to the seventh aspect of the present invention, in this case, it is preferable for the alignment aid unit to switch between the first notification and the second notification according to displacement of the power receiving unit relative to the power supply unit.

A parking aid device according to an eighth aspect of the present invention is equipped to a vehicle that travels by charging a battery by electrical power for battery charging supplied by non-contact, and aids in alignment of a power receiving unit which receives the electrical power for battery charging, relative to a power supply unit which sends the electrical power for battery charging, the parking aid device including: a relative position acquisition unit which acquires a relative position of the power receiving unit relative to the power supply unit; and an alignment aid unit which aids in alignment of the power receiving unit relative to the power supply unit, by notifying a driver of information relative to displacement of the power receiving unit relative to the power supply unit, based on a relative position acquired by the relative position acquisition unit, in which the alignment aid unit is switchable between a first notification that notifies information related to displacement by an image display device which displays an image visible to a driver, and a second notification that notifies the information related to displacement by a vehicle information presenting device which presents in a mode which the driver can confirm by sight or sound.

A vehicle according to a ninth aspect of the present invention includes the parking aid device as described in the eighth aspect.

In the parking aid system according to the first aspect of the present invention, the alignment aid unit is switchable between a first notification which notifies the drive of the information related to displacement of the power receiving unit relative to the power supply unit by way of the image display device, and a second notification which notifies the drive of the information related to displacement of the power receiving unit relative to the power supply unit by way of the vehicle information presenting device. In the present invention, by establishing as switchable between the first notification which notifies the information related to displacement by way of the image display device, and the second notification which notifies the information related to displacement by way of the vehicle information presenting device which is separate from the image display device, since it is possible to configure so that the drive does not closely watch the display screen of the image display device, a decline in the attention of the driver to the vehicle surroundings can be suppressed. In addition, according to the present invention, it is possible to aid in alignment by the second notification, even in a case of the image display device failing.

According to the parking aid system as described in the second aspect of the present invention, the first notification and second notification are switched based on an instruction from the driver. Since it is thereby possible to switch the notification mode according to the preference and skill of the driver, it is possible to achieve convenience for the driver.

According to the parking aid system as described in the third aspect of the present invention, the alignment aid unit changes the interval of the audible tone according to the displacement amount along the vehicle front/rear direction in the second notification, whereby the driver can align the power receiving unit relative to the power supply unit without closely watching the image. It is thereby possible to further suppress a decline in the attention to the vehicle surroundings.

According to the parking aid system as described in the fourth aspect of the present invention, the alignment aid unit changes the flashing pattern of the direction indicator light according to the displacement amount along the vehicle width direction in the second notification, whereby the driver can align the power receiving unit relative to the power supply unit without closely watching the image. It is thereby possible to further suppress a decline in the attention to the vehicle surroundings.

According to the parking aid system as described in the fifth aspect, the alignment aid unit changes at least either of the interval and tone of the warning sound according to the displacement amount along the vehicle front/rear direction in the second notification, whereby the driver can align the power receiving unit relative to the power supply unit without closely watching the image. It is thereby possible to further suppress a decline in the attention to the vehicle surroundings.

According to the parking aid system as described in the sixth aspect of the present invention, the alignment aid unit changes at least either of the interval and tone of sound produced at any of the left speaker and right speaker according to the displacement amount along the vehicle width direction in the second notification, whereby the driver can align the power receiving unit relative to the power supply unit without closely watching the image. It is thereby possible to further suppress a decline in the attention to the vehicle surroundings.

According to the parking aid system as described in the seventh aspect, the alignment aid unit switches between the first notification and the second notification according to the displacement amount of the power receiving unit relative to the power supply unit. Since it is thereby possible to automatically switch to the second notification, in the case of the power supply unit being concealed by the vehicle, and the driver not being able to confirm the power supply unit by sight, for example, it is possible to achieve convenience for the driver.

According to the parking aid device as described in the eighth aspect of the present invention, the same effects as the invention according to the first aspect are exerted.

According to the vehicle as described in the ninth aspect of the present invention, the same effects as the invention according to the first aspect are exerted.

### BRIEF DESCRIPTION OF THE DRAWINGS

FIG. 1 is a block diagram showing a parking aid system according to an embodiment of the present invention;

FIG. 2 is a drawing when viewing a vehicle during alignment parking from above;

FIG. 3 is a view showing an example of first notification by a display screen of an image display device; and

FIG. 4 is a view showing an example of second notification by a meter panel of a vehicle information presenting device.

### DETAILED DESCRIPTION OF THE INVENTION

Hereinafter, a parking aid system according to an embodiment of the present invention will be explained while referencing the drawings.

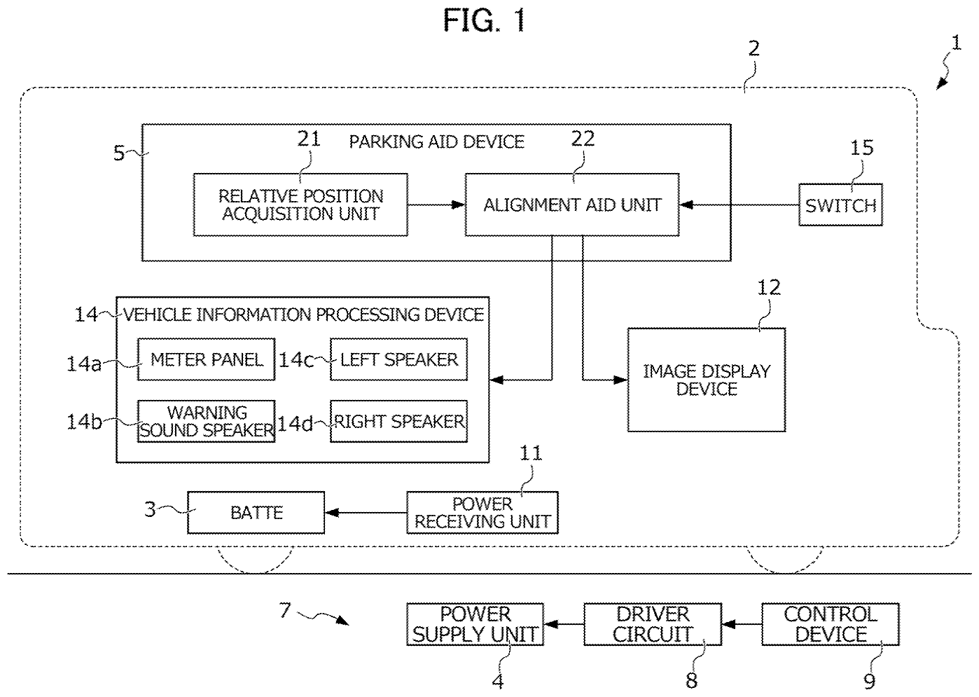

FIG. 1 is a block diagram showing a parking aid system 1 according to the present embodiment. The parking aid system 1 aids in parking of a vehicle 2 to a parking space capable of power supply by non-contact power supply.

The vehicle 2 is an electric vehicle which travels by way of the electrical power of a chargeable/dischargeable battery 3. The battery 3 can widely apply secondary batteries, capacitors, etc. capable of charging/discharging electrical power by which the vehicle 2 can travel, such as a lithium-ion secondary battery or nickel hydride secondary battery. A power supply device 7 which supplies charging electrical power of the battery 3 is provided to the parking space.

The parking aid system 1 includes the power supply device 7 provided to the parking space, and the vehicle 2 equipped with a parking aid device 5 described later.

The power supply device 7 includes: a power supply unit 4 including a power supply coil that sends out electrical power, a drive circuit 8 which drives this power supply unit 4, a control circuit 9 which controls driving of this drive circuit according to an instruction from the vehicle 2, and a wireless communication device (not shown) which performs wireless communication by Wi-Fi (registered trademark), Bluetooth (registered trademark), or the like equipped to the vehicle 2. The power supply unit 4 is installed in the road surface of the parking space. More specifically, the power supply unit 4 is provided at a position facing and close to a power receiving coil provided to the vehicle 2 parked in the parking space. The power supply device 7 sends electrical power for charging by driving of this power supply unit 4.

The vehicle 2 includes: the battery 3; the parking aid device 5; a power receiving unit 11 including the power receiving coil; an image display device 12 which displays an image which is visible to the driver of the vehicle 2; a vehicle information presenting device 14 which presents vehicle information in a mode different from the image display device 12; and a switch 15 which is operable by the driver.

The power receiving unit 11 includes the power receiving coil and a peripheral circuit. The power receiving coil is provided at the bottom of the vehicle 2, so as to be facing and close to the power supply coil provided at this parking space, in the case of parking the vehicle 2 in the parking space. The power receiving unit 11 charges the battery 3 by receiving the electrical power sent from the power supply unit 4 of the power supply device 7 by non-contact. Herein, in the charging method and charge/discharge control of the battery 3, it is possible to widely adopt known configurations.

The image display device 12 is a display which presents various information by image display to the driver and other passengers. As the image display device 12, an image display panel such as a liquid crystal display panel and organic EL panel, a heads-up display or the like can be used. Hereinafter, a case of using the display of a car navigation device as the image display device 12 will be explained; however, the present invention is not to be limited thereto.

The vehicle information presenting device 14 is configured by various devices which present vehicle information in a mode whereby the driver can confirm by sight or sound. More specifically, the vehicle information presenting device 14 includes: a meter panel 14a integrally installed with a speedometer displaying the speed, a tachometer displaying engine speed, directional indicator lights which flash in conjunction with the directional indicators, and audible tone speaker which generates an audible tone, etc.; a warning sound speaker 14b which generates a warning sound of a collision avoidance system that is not shown; a left speaker 14c and right speaker 14d which can produce at least independent sounds at the right and left; and a drive circuit (not shown) of this meter panel 14a, warning sound speaker 14b, left speaker 14c and right speaker 14d.

The switch 15, in response to an operation by the driver, sends to the alignment parking unit 22 a switching signal for switching a notification mode by the alignment aid unit 22 during alignment parking described later, between the first notification and the second notification.

The parking aid device 5 includes a relative position acquisition unit 21 and an alignment aid unit 22. The parking aid device 5 aids in the above-mentioned alignment parking using this relative position acquisition unit 21 and alignment aid unit 22, upon the driver alignment parking the vehicle 2 so that the power receiving unit 11 provided to the vehicle 2 and power supply unit 4 provided to the parking space are opposing at the appropriate position.

The relative position acquisition unit 21 acquires the relative position of the power receiving unit 11 relative to the power supply unit 4. The relative position acquisition unit 21 acquires the relative position by various methods such as a first acquisition method based on LPE (Low Power Excitation) voltage, a second acquisition method based on LF (Low Frequency) waves, a third acquisition method based on GPS (Global Positioning System), and a fourth acquisition method based on an onboard camera.

More specifically, with the first acquisition method, the relative position acquisition unit 21 detects magnetic signals of low output emitted from the power supply unit 4 by a voltage sensor provided to the vehicle 2, and acquires the relative position based on a detection signal (LPE voltage) of this voltage sensor. With the second acquisition method, the relative position acquisition unit 21 emits long-wave magnetic signals from a plurality of antennas provided to the vehicle 2 towards the power supply device 7, the power supply device 7 measures the magnetic signals emitted from the vehicle 2 by a plurality of magnetic sensors provided in the vicinity of the power supply unit 4, and sends this measurement result to the side of the vehicle 2 by a wireless communication device. Furthermore, with this second acquisition method, the relative position acquisition unit 21 acquires the relative position based on the measurement result sent from the power supply device 7. With the third acquisition method, the relative position acquisition unit 21 acquires the relative position based on the GPS system built into the vehicle 2. In addition, with the fourth acquisition method, the relative position acquisition unit 21 acquires the relative position based on images outside of the car obtained by a plurality of cameras built into the vehicle 2.

The alignment aid unit 22 notifies to the driver, via the image display device 12 or the vehicle information presenting device 14, information related to displacement of the power receiving unit 11 relative to the power supply unit 4 based on the relative position acquired by the relative position acquisition unit 21, and thereby aids in the alignment of the power receiving unit 11 relative to the power supply unit 4.

Hereinafter, notification via the image display device 12 is referred to as first notification, and notification via the vehicle information presenting device 14 is referred to as second notification. The alignment aid unit 22 is switchable between the first notification and the second notification based on the switching signal sent from the switch 15.

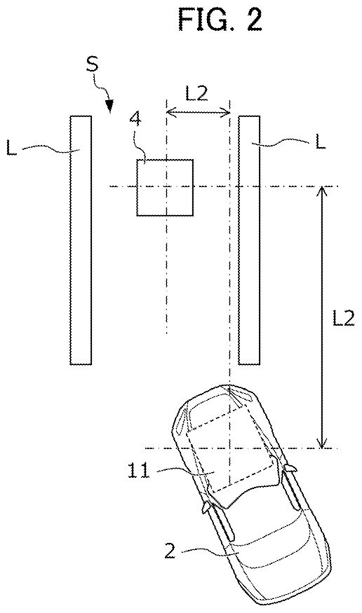

FIG. 2 is a drawing when viewing the vehicle 2 during alignment parking from above. FIG. 2 illustrates a case of parking in a parking space S between two lines L, while making the vehicle 2 advance slightly to the right. The alignment aid unit 22 calculates a front/rear displacement amount L1 which is a displacement amount along the vehicle front/rear direction of the power receiving unit 11 relative to the power supply unit 4; and a right/left displacement amount L2 which is a displacement amount along the vehicle width direction of the power receiving unit 11 relative to the power supply unit 4, based on the relative position of the power receiving unit 11 relative to the power supply unit 4 acquired by the relative position acquisition unit 21, and performs the first notification or second notification in a mode decided based on this front/rear displacement amount L1 and right/left displacement amount L2.

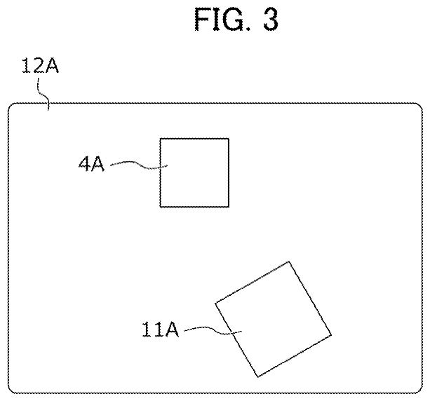

FIG. 3 is a view showing an example of the first notification by the display screen 12A of the image display device 12. The alignment aid unit 22, in the case of the first notification being selected as the notification mode according to operation of the switch 15 by the driver, aids in alignment of the power receiving unit 11 relative to the power supply unit 4, by displaying an image such as that shown in FIG. 3, on the display screen 12A of the image display device 12. More specifically, the alignment aid unit 22, as shown in FIG. 3, aids in alignment of the power receiving unit 11 relative to the power supply unit 4, by displaying a rectangular marker 4A indicating the power supply unit 4 and a rectangular marker 11A indicating the power receiving unit 11 respectively at positions calculated based on the front/rear displacement amount L1 and right/left displacement amount L2 on the display screen 12A.

According to the first notification via the above such image display device 12, the driver comes to drive the vehicle 2, while visually confirming the display image 12A. For this reason, as the driver focuses on the display screen 12A, their attention to the surroundings of the vehicle 2 may decline. In addition, in the case of the image display device 12 failing, it will not be possible to aid in driving according to the first notification. Therefore, the alignment aid unit 22, in the case of the second notification being selected as the notification mode according to operation of the switch 15 by the driver, notifies information related to displacement of the power receiving unit 11 relative to the power supply unit 4 to the driver by the vehicle information presenting device 14, which is separate from the image display device 12.

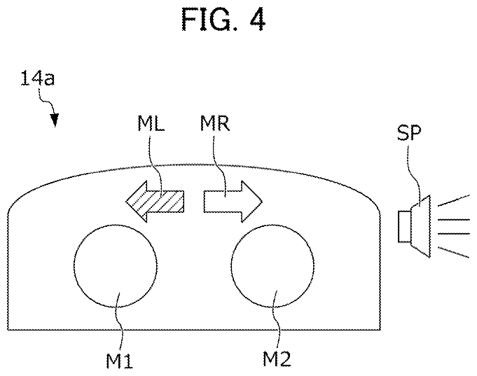

FIG. 4 is a view showing an example of the second notification by the meter panel 14a of the vehicle information presenting device 14. A speedometer M1, a tachometer M2, a left directional indicator light ML, a right directional indicator light MR and an audible tone speaker SP are provided to the meter panel 14A.

The alignment aid unit 22, in the case of the second notification being selected as the notification mode according to operation of the switch 15 by the driver, aids in alignment of the power receiving unit 11 relative to the power supply unit 4, by intermittently producing an audible tone from the audible tone speaker SP, and intermittently flashing the directional indicator lights ML, MR, in the mode determined based on the front/rear displacement amount L1 and/or right/left displacement amount L2.

The alignment aid unit 22 changes the interval of the audible tone produced from the audible tone speaker SP in response to the front/rear displacement amount L1. More specifically, the alignment aid unit 22 shortens the interval of the audible tone produced from the audible tone speaker SP as the front/rear displacement amount L1l becomes smaller. It is thereby possible to align the position along the front/rear direction of the vehicle 2 of the power receiving unit 11 relative to the power supply unit 4, without watching the display screen 12A.

The alignment aid unit 22 changes the flashing patterns of the directional indicator lights ML, MR in response to the right/left displacement amount L2. More specifically, the alignment unit 22 flashes the left directional indicator light ML in the case of the power supply unit 4 being displaced to the left side viewing from the power receiving unit 11 (case shown in FIG. 2), and flashes the right directional indicator light MR in the case of the power supply unit 4 being displaced to the right side viewing from the power receiving unit 11. In addition, the alignment aid unit 22 preferably shortens the flashing cycle of these directional indicator lights ML, MR as the right/left displacement amount L2 becomes smaller. In addition, the alignment aid unit 22 may always illuminate these directional indicator lights ML, MR in the case of the right/left displacement amount L2 becoming no more than a predetermined permitted range. The driver can thereby align the position along the vehicle width direction of the vehicle 2 of the power receiving unit 11 relative to the power supply unit 4, without watching the display screen 12A.

Although an example of the second notification by the meter panel 14a was explained by referencing FIG. 4, the present invention is not to be limited thereto. The alignment aid unit 22 may aid in alignment of the power receiving unit 11 relative to the power supply unit 4, by producing sound from the warning sound speaker 14b of the collision avoidance system or the speakers 14c, 14d, in a mode determined based on the front/rear displacement amount L1 and/or right/left displacement amount L2.

The alignment aid unit 22 may change at least either of the interval or tone of the warning sound produced from the warning sound speaker 14b in response to the front/rear displacement amount L1. More specifically, the alignment aid unit 22 may shorten the interval of the warning sound produced from the warning sound speaker 14b, or may change the tone of the warning sound, as the front/rear displacement amount L1 becomes smaller. It is thereby possible to align the position along the front/rear direction of the vehicle 2 of the power receiving unit 11 relative to the power supply unit 4, without watching the display screen 12A.

In addition, the alignment aid unit 22 may change at least either of the interval and tone of sound produced at either of the left speaker 14c and right speaker 14d in response to the right/left displacement amount L2. More specifically, the alignment aid unit 22 may produce sound from the left speaker 14c in the case of the power supply unit 4 being displaced to the left side viewed from the side of the power receiving unit 11 (case shown in FIG. 2), or may produce sound from the right speaker 14d in the case of the power supply unit 4 being displaced to the right side viewed from the side of the power receiving unit 11. In addition, the alignment aid unit 22 may shorten the interval of sound produced at these speakers 14c, 14d, or may change the tone of sound produced at these speakers 14c, 14d, as the right/left displacement amount L2 becomes smaller. The driver can thereby align the position along the vehicle width direction of the vehicle 2 of the power receiving unit 11 relative to the power supply unit 4, without closely watching the display screen.

Although a case of the alignment aid unit 22 switching the notification mode between the first notification and the second notification based on the switching signal sent from the switch 15 has been explained above, the present invention is not to be limited thereto. The alignment aid unit 22 may switch the notification mode between the first notification and the second notification according to the displacement amount of the power receiving unit 11 relative to the power supply unit 4. More specifically, the alignment aid unit 22 may notify the driver of information related to displacement by the first notification in the case of the displacement amount of the power receiving unit 11 relative to the power supply unit 4 being larger than a predetermined threshold, and may notify the driver of information related to displacement by the second notification in the case of the displacement amount being smaller than the above-mentioned threshold. This is particularly useful in the case of the image display device 12 failing, and the driver needing to confirm the position of the power supply unit 4 by sight. In this case, when the power receiving unit 11 approaches the power supply unit 4, since the power supply unit 4 is concealed by the vehicle 2, the driver cannot confirm the power supply unit 4 by sight. In contrast, the alignment aid unit 22 can appropriately aid in alignment by the vehicle information presenting device 14, by switching the notification mode from the first notification to the second notification in response to the displacement amount becoming smaller than the predetermined threshold.

According to the parking aid system 1, parking aid device 5 and vehicle 2 of the present embodiment, the following effects are exerted.

(1) In the present embodiment, by establishing as switchable between the first notification which notifies the information related to displacement by way of the image display device 12, and the second notification which notifies the information related to displacement by way of the vehicle information presenting device 14 which is separate from the image display device 12, since it is possible to configure so that the drive does not closely watch the display screen 12A of the image display device 12, a decline in the attention of the driver to the vehicle surroundings can be suppressed. In addition, according to the present embodiment, it is possible to aid in alignment by the second notification, even in a case of the image display device 12 failing.

(2) According to the present embodiment, the first notification and second notification are switched based on operation of the switch 15 by the driver. Since it is thereby possible to switch the notification mode according to the preference and skill of the driver, it is possible to achieve convenience for the driver.

(3) According to the present embodiment, the alignment aid unit 22 changes the interval of the audible tone according to the front/rear displacement amount L1 in the second notification, whereby the driver can align the power receiving unit 11 relative to the power supply unit 4 without closely watching the image displayed on the display screen 12A. It is thereby possible to further suppress a decline in the attention to the surroundings of the vehicle 2.

(4) According to the present embodiment, the alignment aid unit 22 changes the flashing pattern of the direction indicator lights ML, MR according to the right/left displacement amount L2 in the second notification, whereby the driver can align the power receiving unit 11 relative to the power supply unit 4 without closely watching the image displayed on the display screen 12A. It is thereby possible to further suppress a decline in the attention to the surroundings of the vehicle 2.

(5) According to the present embodiment, the alignment aid unit 22 changes at least either of the interval and tone of the warning sound according to the right/left displacement amount L2 in the second notification, whereby the driver can align the power receiving unit 11 relative to the power supply unit 4 without closely watching the image displayed on the display screen 12A. It is thereby possible to further suppress a decline in the attention to the surroundings of the vehicle 2.

(6) According to the present embodiment, the alignment aid unit 22 changes at least either of the interval and tone of sound produced at any of the left speaker 14c and right speaker 14d according to the right/left displacement amount in the second notification, whereby the driver can align the power receiving unit 11 relative to the power supply unit 4 without closely watching the image displayed on the display screen 12A. It is thereby possible to further suppress a decline in the attention to the surroundings of the vehicle 2.

(7) According to the present embodiment, the alignment aid unit 22 switches between the first notification and the second notification according to the displacement amount of the power receiving unit 11 relative to the power supply unit 4. Since it is thereby possible to automatically switch to the second notification, in the case of the power supply unit 4 being concealed by the vehicle 2, and the driver not being able to confirm the power supply unit 4 by sight, for example, it is possible to achieve convenience for the driver.

Although an embodiment of the present invention has been explained above, the present invention is not to be limited thereto. The configuration of detailed parts may be appropriately modified within a scope of the gist of the present invention. For example, in the above-mentioned embodiment, a case of switching the notification mode by operation of the switch 15 was explained; however, the present invention is not to be limited thereto. The notification mode may be switched by the voice of the driver.

What is claimed is:

1. A parking aid system which aids in parking of a vehicle to a parking space that supplies electrical power for battery charging by non-contact,
wherein a power supply unit for sending the electrical power for battery charging is provided to the parking space,
wherein the vehicle includes:
a power receiving unit that receives the electrical power for battery charging sent by the power supply unit;
a relative position acquisition unit which acquires a relative position of the power receiving unit relative to the power supply unit;
an alignment aid unit which aids in alignment of the power receiving unit relative to the power supply unit, by notifying a driver of information related to displacement of the power receiving unit relative to the power supply unit, based on the relative position acquired by the relative position acquisition unit;
an image display device which displays an image visible to the driver; and
a vehicle information presenting device which presents vehicle information in a mode which the driver can confirm by sight or sound,
wherein the alignment aid unit is switchable between a first notification which notifies information related to the displacement by way of the image display device, and a second notification which notifies the information related to the displacement by way of the vehicle information presenting device.

2. The parking aid system according to claim 1, wherein the alignment aid unit switches between the first notification and the second notification according to an instruction from the driver.

3. The parking aid system according to claim 1, wherein the vehicle information presenting device includes an audible tone speaker which produces an audible tone, and wherein the alignment aid unit changes an interval of an audible tone according to a displacement amount along a vehicle front/rear direction of the power receiving unit relative to the power supply unit, in the second notification.

4. The parking aid system according to claim 1, wherein the vehicle information presenting device includes a directional indicator light, and
wherein the alignment aid unit changes a flashing pattern of the directional indicator light according to a displacement amount along a vehicle width direction of the power receiving unit relative to the power supply unit, in the second notification.

5. The parking aid system according to claim 1, wherein the vehicle information presenting device includes a warning sound speaker which produces a warning sound of a collision avoidance system, and
wherein the alignment aid unit changes at least either or an interval and a tone of the warning sound according to a displacement amount along a vehicle front/rear direction of the power receiving unit relative to the power supply unit, in the second notification.

6. The parking aid system according to claim 1, wherein the vehicle information presenting device includes at least a left speaker and a right speaker which can produce sound independently at left and right, and
wherein the alignment aid unit changes at least either of an interval and tone of sound produced at either of the left speaker and the right speaker according to a displacement amount along a vehicle width direction of the power receiving unit relative to the power supply unit.

7. The parking aid system according to claim 1, wherein the alignment aid unit switches between the first notification and the second notification according to a displacement amount of the power receiving unit relative to the power supply unit.

8. The parking aid system according to claim 2, wherein the vehicle information presenting device includes an audible tone speaker which produces an audible tone, and
wherein the alignment aid unit changes an interval of an audible tone according to a displacement amount along a vehicle front/rear direction of the power receiving unit relative to the power supply unit, in the second notification.

9. The parking aid system according to claim 2, wherein the vehicle information presenting device includes a directional indicator light, and
wherein the alignment aid unit changes a flashing pattern of the directional indicator light according to a displacement amount along a vehicle width direction of the power receiving unit relative to the power supply unit, in the second notification.

10. The parking aid system according to claim 2, wherein the vehicle information presenting device includes a warning sound speaker which produces a warning sound of a collision avoidance system, and
wherein the alignment aid unit changes at least either or an interval and a tone of the warning sound according to a displacement amount along a vehicle front/rear direction of the power receiving unit relative to the power supply unit, in the second notification.

11. The parking aid system according to claim 2, wherein the vehicle information presenting device includes at least a left speaker and a right speaker which can produce sound independently at left and right, and
wherein the alignment aid unit changes at least either of an interval and tone of sound produced at either of the left speaker and the right speaker according to a displacement amount along a vehicle width direction of the power receiving unit relative to the power supply unit.

12. The parking aid system according to claim 2, wherein the alignment aid unit switches between the first notification and the second notification according to a displacement amount of the power receiving unit relative to the power supply unit.

13. The parking aid system according to claim 8, wherein the vehicle information presenting device includes a directional indicator light, and
wherein the alignment aid unit changes a flashing pattern of the directional indicator light according to a displacement amount along a vehicle width direction of the power receiving unit relative to the power supply unit, in the second notification.

14. The parking aid system according to claim 13, wherein the vehicle information presenting device includes a warning sound speaker which produces a warning sound of a collision avoidance system, and
wherein the alignment aid unit changes at least either or an interval and a tone of the warning sound according to a displacement amount along a vehicle front/rear direction of the power receiving unit relative to the power supply unit, in the second notification.

15. The parking aid system according to claim 14, wherein the vehicle information presenting device includes at least a left speaker and a right speaker which can produce sound independently at left and right, and
wherein the alignment aid unit changes at least either of an interval and tone of sound produced at either of the left speaker and the right speaker according to a displacement amount along a vehicle width direction of the power receiving unit relative to the power supply unit.

16. The parking aid system according to claim 15, wherein the alignment aid unit switches between the first notification and the second notification according to a displacement amount of the power receiving unit relative to the power supply unit.

17. A parking aid device which is equipped to a vehicle that travels by charging a battery by electrical power for battery charging supplied by non-contact, and aids in alignment of a power receiving unit which receives the electrical power for battery charging, relative to a power supply unit which sends the electrical power for battery charging, the parking aid device comprising:
a relative position acquisition unit which acquires a relative position of the power receiving unit relative to the power supply unit; and
an alignment aid unit which aids in alignment of the power receiving unit relative to the power supply unit, by notifying a driver of information relative to displacement of the power receiving unit relative to the power supply unit, based on a relative position acquired by the relative position acquisition unit,
wherein the alignment aid unit is switchable between a first notification that notifies information related to displacement by an image display device which displays an image visible to a driver, and a second notification that notifies the information related to displacement by a vehicle information presenting device which presents in a mode which the driver can confirm by sight or sound.

18. A vehicle comprising the parking aid device according to claim 17.
